(19) United States
(12) Patent Application Publication
(10) Pub. No.: US 2010/0148093 A1
(43) Pub. Date: Jun. 17, 2010

(54) COVERT ILLUMINATION

(76) Inventor: David Mark Benton, Malvern (GB)

Correspondence Address: NIXON & VANDERHYE, PC, 901 NORTH GLEBE ROAD, 11TH FLOOR, ARLINGTON, VA, 22203, US

(21) Appl. No.: 12/451,480

(22) PCT Filed: May 13, 2008
(86) PCT No.: PCT/GB2008/001655

§ 371 Date: Nov. 13, 2009

(30) Foreign Application Priority Data
May 14, 2007 (GB) 0709226.5

(51) Int. Cl. F21K 99/00; H01S 3/10

(52) U.S. Cl. 250/492.1; 372/20

(57) ABSTRACT

This invention relates to methods and apparatus for covert illumination. The method involves illuminating the scene with light which is tuned to an absorption resonances of atmospheric oxygen gas. Light tuned to have a wavelength corresponding to an oxygen absorption wavelength travelling through the atmosphere is therefore attenuated by absorption. The method therefore teaches that a low power illumination source can be used to illuminate nearby objects, thus allowing the detail thereof to be resolved, and the illuminating light reflected from the object, or even the light source itself, will be undetectable beyond a certain range due to atmospheric absorption. The illumination may be used in conjunction with the use of low light level imagers to image a scene. Alternatively the illumination could be used for short range optical communication which will be undetectable at much longer range.

This invention relates to the covert optical sources especially such sources used for covert illuminations and covert optical communication.

Military or police personnel often operate under cover of darkness. There is a need, in operating in such conditions, to be able to operate in a covert manner so as to avoid detection. Imaging systems capable of operating in low light levels have been around for some time. Starlight cameras, image intensifiers or night vision goggles are now common place and readily commercially available. These utilise intensified CCD cameras (ICCD) to provide a large amount of gain and are extremely sensitive. They provide usable images of a scene with levels of lighting that are too dark to be seen with the unaided eye. However the low ambient light levels may still be insufficient to allow the resolution of detail in a close quarter activity, such as map reading for example. In these circumstances an additional source of illumination is required. This can pose a problem to a covert operation as the source will be detectable to distant observers, particularly those using an image intensifier.

French Patent application FR2716978A describes a mobile robotic vehicle for remote observation. The vehicle may be provided with an active vision system in which a radiation source illuminates the scene and a camera detects reflected radiation. To minimise the chance of detection of the mobile vehicle the illuminating radiation is adapted to have a wavelength which is attenuated in the atmosphere by absorption. Use of radiation having a wavelength which corresponds to absorption band due to water vapour or carbon dioxide is taught. Water vapour has a relatively strong absorption—however the amount of water vapour present can vary in different regions with the result that the degree of absorption will also vary.

The present invention resides in an improved method of covert illumination. Thus according to the present invention there is provided a method of covert illumination comprising illuminating the scene with an optical source having an optical output tuned to an absorption wavelength of atmospheric oxygen gas.

An absorption wavelength is a wavelength at which radiation is absorbed by atmospheric oxygen. The optical source is tuned to illuminate the scene with radiation which matches the atmospheric absorption wavelength of oxygen gas. The absorption of light by the oxygen gas in the atmosphere ensures that there is a limited range at which observation can be made, beyond this range the remaining light level is so low that it cannot be distinguished from noise. Thus the illumination is covert beyond a certain range.

Thus the method allows the source to illuminate objects near to the source, for instance a user may hold the source close to a map. The optical path from the source to the nearby object is relatively short and therefore there is a limited amount of atmospheric absorption. Thus the additional illumination can allow the detail of the nearby object to be resolved. Any light not directed directly towards the object or light reflected from the object will also undergo atmospheric absorption but, over a longer distance the cumulative effect will significantly reduce the light level thus rendering the source effectively covert beyond a certain range.

The method may be used in conjunction with use of a low light imager, such as night vision goggles or the like. Use of such a low light imager means that only low levels of illumination are needed. Obviously the wavelength range of operation of the low light imager should include the wavelength of the source. CCD cameras typically have a response that extends into the near infrared. As used throughout this specification therefore the term light shall mean not only visible electromagnetic radiation but also electromagnetic radiation which is outside of, but close to, the visible spectrum, such as near infrared radiation. The term optical source shall therefore mean a source of light as herein defined and so includes a source emitting radiation purely in the near infrared.

Oxygen gas (O₂) has an absorption at a wavelength around 760 nm. The attenuation length (1/e) for this absorption in atmospheric O₂ is 50 m which means that a 1 mw source will be attenuated by a factor of 10⁻¹⁰ at a distance of 1 km, thereby making it covert even for direct illumination. In practice such a source will be well directed and contained and the diffuse scatter of this source will be all that is visible, bringing the covert range down significantly.

The absorption due to oxygen around 760 nm is not as strong as the absorption due to water vapour or carbon dioxide, the absorption bands suggested in FR 2716978. This atmospheric absorption band would not therefore be the obvious choice for a covert illumination means as other wavelengths would be more strongly attenuated and therefore more covert. However the present inventor has realised there are distinct advantages in using this absorption band.

First the absorption around 760 nm is near the peak response of intensified CCD cameras. The extreme sensitivity of ICCD cameras means that the source can be very weak (of the order microwatts) and still render a usable image of the scene. The use of a wavelength which is near the peak response of the ICCD cameras thus allows a lower power source to be used compared with what would be needed at a different wavelength. The radiated power is a large factor in the covertness of the illumination means and hence use of a low power source at a wavelength which does exhibit reasonable absorption in the atmosphere results in a very covert source for instance the covert range may be below 100 m.

The oxygen absorption resonance around 760 nm is one of the strongest oxygen absorptions and the wavelength is, as mentioned, near the peak response of some ICCDs. However the skilled person will appreciate that there are other known absorption resonances of oxygen gas which could be used as to define the atmospheric absorption wavelength. Some of these other absorption wavelengths may be advantageous in particular applications.

The use of an atmospheric absorption wavelength corresponding to absorption of oxygen gas is also advantageous over using a wavelength associated with absorption of water vapour because the amount of oxygen in the atmosphere is constant across the planet and does not vary with temperature. Thus, the amount of absorption will be constant and the covert range will be well defined whereas the amount of water vapour in the atmosphere varies with temperature and humidity, which means the amount of absorption per unit length and hence the covert range using an absorption wavelength based on water vapour, is variable.

The intensity of light emitted by the optical source will depend on the particular application it is being used for. However a well controlled, directed source for illuminating nearby objects may only need a source of less than 1 milliwatt to provide acceptable illumination. With high sensitivity imagers, such as ICCDs, illumination levels of the order of a few microwatts are sufficient, e.g. less than 100 microwatts, or less than 50 microwatts or less than 10 microwatts. Where transmission over distances such as 100 m is required then power levels of the order of 1 milliwatt or more may be required.

The method may involve controlling the divergence of the source so that only limited viewing directions could see the source directly. This will limited the field of view where the source could be detected. The illumination is preferably arranged so that the when used to illuminate a nearby object substantially all the radiation emitted by the source is incident on the object. Thus the object itself will block transmission of radiation from the source and the only light emitted to the environment will be light reflected from the object.

The optical output of the source may be pulsed and the pulse timing may be arranged to be synchronous with image acquisition of a gated low light level imager. Some low light level imagers such as intensified CCD cameras are gated, i.e. arranged to acquire radiation only at certain times during a duty cycle. If the optical source is pulsed in synchronicity with the gate of the low light level imager the imager will acquire an image of the illuminated scene but the overall intensity of the source will be reduced as compared with using a constant source.

The optical source may be any apparatus which emits a narrow band optical output at the correct wavelength, for instance the optical source may conveniently comprise a laser such as a diode laser.

Whilst it may be possible to use a device that inherently emits light at the correct wavelength other devices may need continual tuning to ensure that the output has the correct output. For instance the wavelength of the output of a laser can vary with temperature. The method may therefore involve the step of maintaining the wavelength of the source at the absorption wavelength of atmospheric oxygen.

Various methods for ensuring a constant wavelength output from an optical source are known. It should be noted that in the fields of gas sensing or optical spectroscopy it is known to illuminate a sample of gas with at least one wavelength which corresponds an absorption wavelength of a target molecule, for instance oxygen (O₂). After one or more passes through the sample the intensity of radiation at that wavelength can be analyzed to determine the extent of absorption and hence the amount of the target gas, if any, in the sample. Thus optical sources with an optical output tuned to an absorption wavelength of oxygen are known. The present invention resides at least partly in the application of such sources to covert illumination and covert imaging.

In such gas sensing systems a laser is often wavelength locked to the absorption resonance of a target molecule, by passing at least some of the output through a known sample of the target molecule and monitoring the level of absorption as the laser wavelength is varied. A feedback system is then applied to the source to keep the wavelength at the peak of the absorption. The sample of the target molecular species is kept isolated in a transparent cell, usually glass. This provides a contamination free reference with potentially much higher density than might exist in, say open atmosphere. Whilst this works well, glass sample cells are fragile and often relatively large. Where the molecular absorption is weak, a significant length of absorbing gas will be required to ensure stable wavelength locking. This can be achieved by multiple reflections through the cell.

Advantageously therefore the reference sample may be provided in one or more photonic bandgap (PBG) fibres capable of transmitting light at the particular atmospheric absorption wavelength. Photonics bandgap fibres are optical fibres consisting of an array of holes, normally air filled, running along the length of the fibre. These serve to restrict the possible wavelengths that can be transmitted through the fibre. Gas present within the holes can interact with the light travelling along the fibre. This technique has recently been demonstrated using acetylene gas within a PBG fibre Nature 434, 488-491 (24 Mar. 2005), where the gas was used to wavelength lock a diode laser, at wavelengths of interest in the field of communications. The presence of, for example oxygen, in these holes will absorb transmitted light in much the same way as oxygen in a glass cell would and could be used to monitor the absorption with wavelength and stabilise the laser wavelength. However the fibre is much more robust than a glass cell. Because the fibre contains the light within it, long absorption/interaction lengths can be achieved. The fibre is lightweight and flexible and many metres can be coiled into a small space. With relatively weak absorption such as with oxygen, all the laser intensity can pass through the PBG fibre without severely affecting the final output power. A known fraction of this can then be picked off and used for maintaining the wavelength stabilisation. The captive gas within the fibre can be air, with the fibre ends open to the atmosphere, or for instance pure oxygen with the ends sealed.

This approach is applicable to any stable gas that can be contained within the fibre and so also applicable to water vapour (with a suitable change of wavelength).

The method of the present invention can therefore be implemented using compact, lightweight, robust and low power apparatus—all of which are advantageous in many applications. The skilled person will of course be aware of other methods of wavelength locking that could be applied to the present invention. For instance the absolute value of the wavelength could be measured and the source tuned accordingly. Light reflected from the object illuminated could be analyzed for peak absorption. Light scattered from a local volume of external atmospheric gas could also be used to monitor the absorption.

As mentioned the method of the present invention may advantageously be used in conjunction with the use of low light level imagers. Another aspect of the invention therefore is covert low level imaging comprising illuminating a scene with an optical source having an optical output tuned to an absorption wavelength of atmospheric oxygen and imaging the scene with a low light level imager responsive to the wavelength of illumination. The low light level imager may be any low level light imager such as an intensified CCD imager.

The method of the present invention can be used to illuminate objects, such as personal equipment or documents, so as to make them clearly visible, possibly via a low light level imager, in darkness. In another aspect of the invention the light transmitted to the scene may be modulated to enable communication. The method of the present invention may therefore comprise the step of modulating the optical output with a data encoding.

As mentioned above the light transmitted by the optical source is tuned to an atmospheric absorption wavelength of oxygen absorption such as around 760 nm. Light at this wavelength will be attenuated passing through the atmosphere. As mentioned above light passing through a few metres of atmosphere will be attenuated slightly whereas light passing through several hundred metres of atmosphere will be attenuated very strongly. Thus, through use of an appropriate intensity of source it is possible to transmit a beam of light that can be detected sufficiently to determine the modulation thereof over a distance of say up to about 100 metres but which is undetectable at a distance of 1 km of more away.

The modulation could be intensity modulation, or time modulation, or a combination of both.

The method could allow simple optical communication between personnel using low light level imagers, for instance communicating using Morse code or some other pre-agreed code. However the method could also be used in a point to point speed optical communication system. A focussed beam could be produced and binary intensity modulated using readily available optical data modulation equipment commonly used in the telecommunications industry. The modulated signal is transmitted through the atmosphere to an appropriate receiver comprising a high speed detector and a processor which decodes the signal. A targeted optical system can be used to ensure that the transmitted beam is incident on the receiver and to reduce the amount of transmitted light which is not incident on the receiver. Nevertheless, any light overspill which bypasses the receiver will be attenuated by atmospheric absorption. Thus a reliable communication link operating over 100 m say could be established which would be undetectable more than 1 km away. The communication link can, as mentioned, be high speed, and be acoustically silent and also radio silent, i.e. with no rf emission.

The method could also allow an optical broadcast mode, i.e. the source could produce a wide angle or even omnidirectional, much as a radio broadcast is done. This could be done with confidence, in the knowledge that the emission from the central broadcast point will not be decipherable to non-local observers, say within a secure base, and will be totally covert at about 1 km distance.

The method of the present invention therefore also provide a covert method of free space optical communication comprising the steps of transmitting a light beam to a remote receiver, the light beam having a data encoding modulation, wherein the light beam has a wavelength which is matched to an absorption wavelength of atmospheric oxygen.

As mentioned above the use of photonic bandgap fibres offers a means of wavelength locking a laser to an atmospheric absorption wavelength which is compact, lightweight and robust. This can be applied to lock the source to the absorption wavelength of oxygen or indeed to any atmospheric absorption band, for instance the wavelengths absorbed by water vapour or carbon dioxide. Thus in another aspect of the invention there is provided an optical source tuned to an atmospheric absorption wavelength comprising a laser having a feedback control means for wavelength locking the laser output to the atmospheric absorption wavelength, wherein the feedback control means passes at least some of the laser output through a sample of the target atmospheric constituent and analyses the intensity thereof and wherein the target atmospheric constituent is held within a photonic bandgap fibre which is transmissive at the atmospheric absorption wavelength.

All of the laser output may pass through the photonic bandgap fibre and in this case a portion of the optical source may comprise means for directing part of the radiation exiting the photonic bandgap fibre to a detector.

The atmospheric absorption wavelength could correspond to an absorption of oxygen gas or water vapour. For oxygen the absorption wavelength could be around 760 nm. For water vapour the absorption wavelength could be around 1.38 μm or around 1.84 μm.

The photonic bandgap fibre may be sealed with the atmospheric constituent disposed inside or the fibre may be open ended and thus filled with air.

Various aspects and embodiments of the invention have been described. The skilled person will appreciate however that the invention in general relates to the use of light having a wavelength which is absorbed by oxygen gas in the atmosphere as a illuminating source for covert illumination and in particular for low light level imaging and also to the use of light having a wavelength which is absorbed by the atmosphere in a short range, covert optical communication system.

The invention will now be described by way of example only with respect to the following figures of which;

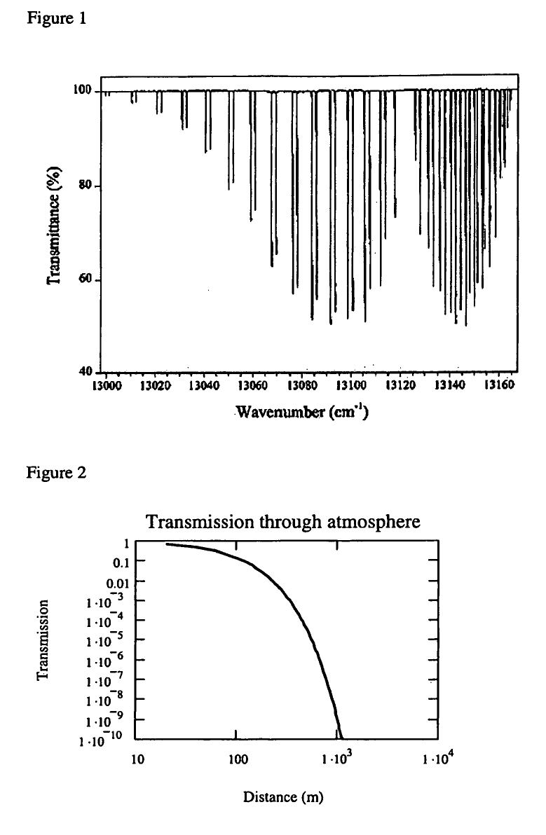

FIG. 1 shows the molecular oxygen absorption band around 760 nm,

FIG. 2 shows the relative transmission against distance through the atmosphere for the strongest oxygen absorbing line,

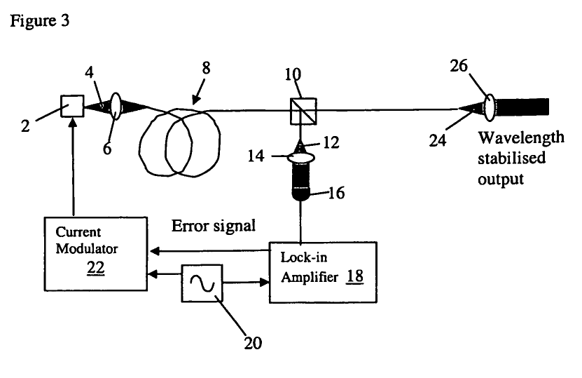

FIG. 3 shows a schematic diagram of a wavelength locked optical source.

Intensified charged coupled device (ICCD) imagers are readily available and often used by military or police personnel operating under cover of darkness where there is a desire to operate undetected by any observers. The use of night vision goggles for instance allow personnel to operate and observe in near total darkness.

In some situations however the low ambient light level may not allow the imager to resolve sufficient detail for some close quarter activities such as map reading. In such case an additional source of illumination is needed. Use of a light source runs the risk however of identifying one's presence and location to an observer, especially if the observer themselves is equipped with night vision goggles.

The present invention addresses this problem by providing a method and apparatus for illumination that provides sufficient additional light but that minimises the risk of detection. The present invention illuminates the scene with a low power light source which is tuned to an absorption resonance of oxygen.

It is well known that molecular species have absorption resonances at certain wavelengths. Oxygen has several narrow absorptions in a band around 760 nm which are suitable. This is especially advantageous as it is near the peak response of some ICCDs and is just outside the visible range, reducing the possibility of detection by the unaided eye.

FIG. 1 shows the transmissivity through oxygen as a function of wavenumber around 760 nm. It can be seen that there are a number of different wavelengths at which absorption occurs to a varying extent. Any of these wavelengths can be used but obviously a wavelength corresponding to a stronger absorption will exhibit a greater effect.

The attenuation length (1/e) of radiation corresponding to the stronger absorption lines within this 760 nm band is approximately 50 m. Therefore the intensity is reduced approximately 63% by atmospheric absorption over 50 m. This means that minimal absorption occurs over a few metres. For a covert illuminator required to give additional lighting for close quarter operations, such as map reading, the required range will be of the order of a metre and there will be minimal absorption over this range. However going beyond this range the cumulative effect of the absorption builds up. At about 100 m the intensity will be reduced by half and at 1 km the intensity will be attenuated by a factor of 10⁻¹⁰. Thus beyond a certain range the illumination will be indistinguishable from noise. FIG. 2 shows the transmission through the atmosphere of light having a wavelength corresponding to the strongest absorption line at around 760.4 nm.

The optical source may be a laser which is wavelength locked to an absorption wavelength of oxygen. FIG. 3 shows a suitable means of wavelength locking a laser which is compact, lightweight and robust. A prototype system was constructed in order to examine the absorption effects. Diode laser 2 (Supplied by Toptica photonics AG, Munich, Germany) is driven to produce a laser beam 4 having a nominal wavelength corresponding to one of the strong absorption lines of oxygen around 760 nm. This laser beam is coupled by lens 6 into a photonic band gap fibre 8 (Supplied by Crystal Fibre, Denmark) which has a transmission window around 760 nm and which is filled with either pure oxygen or air. As the skilled person will be well aware photonic bandgap fibres are optical fibres consisting of an array of holes running along the length of the fibre which serve to restrict the possible wavelengths that can be transmitted through the fibre. Because the fibre contains the light within it, long absorption/interaction lengths can be achieved. The fibre is lightweight and flexible and many metres can be coiled into a small space. In the prototype system 15 m, of PBG fibre was used with both and air filling and also predominantly oxygen filling.

Light exiting the photonic bandgap fibre 8 is incident on beam splitter 10 which directs a small portion 12 of the light, via lens 14, onto a detector 16. The detector output is connected to a lock-in amplifier 18 which also receives a signal from reference oscillator 20. The lock-in amplifier measures any change in absorption and provides an error signal to current modulator 22 which drives the laser so as to keep the laser output tuned to the absorption line wavelength.

Only a small amount of the laser output is used in the feedback control, the majority of the beam 24 is directed to transmit optics 26 where it is directed onto towards the scene.

The manner in which the light is directed towards the scene may vary depending on the application and the covert optical source may for instance have a variable intensity and beam divergence that can be altered depending on the circumstance. To take the example of a user wishing to illuminate a map so that the detail of the map can be resolved by night vision goggles the source could be held close to the map and only a small area of the map may need to be illuminated at any one time. Thus the intensity of light transmitted will be low. Further all the transmitted light will be directed onto the map and so only radiation diffusely scattered by the map will escape to the environment, thus reducing the intensity of light available to be detected by an observer. Even though the atmospheric absorption over a few metres is relatively low it will further reduce the intensity to such a low level that it will be indistinguishable from noise of an ICCD. Hence beyond about 200 m the covert light source would be undetectable.

Were the light source used to illuminate a wider area however it may be necessary to widen the beam divergence and possibly increase the intensity of illumination. Obviously this could increase the range at which the illumination could be detected but the significant attenuation over distances of the order of 1 km mean that the illumination would have to be quite intense to be detected beyond this range and it is envisaged it would not be often that such a highly intense source of illumination would be needed.

The prototype illuminator has been tested over an absorption range of 90 m and a significant difference has been seen in the transmitted light level when compared with light that is not tuned to an absorption line. The detected light from an illuminated target was much reduced as viewed with sensitive imaging devices (night vision goggles). This is taken as proof that this illuminator system is effective at enhancing the covertness of an illumination source if required.

The incorporation of a PBG fibre as the wavelength locking element allows the prospect of an all optical fibre based system being constructed. Such a system would comprise a laser coupled into an optical fibre, with fibre coupling into fibre splitters and subsequent connection to the PBG fibre and fibre based delivery of the light intended for illumination. This would then be a flexible, compact and rugged illuminator system.

The present invention may also be used to provide a covert, local optical communication device. The apparatus of FIG. 3 may be used to produce a beam of light for transmission that is modulated by an intensity modulator (not shown) responsive to a data stream. The modulated data is then transmitted to a receiver which decodes the data. Targeted focussing optics can be used to ensure that the beam is transmitted to the receiver with minimal overspill, i.e. minimal amounts of radiation being transmitted past the receiver. However some degree of overspill may be inevitable. As shown in FIG. 2 however a signal transmitted over 100 m is attenuated by a noticeable amount but a signal transmitted over 1 km is attenuated to a significantly greater degree. Therefore a signal of appropriate intensity could be satisfactorily transmitted over a hundred metres or so but would be undetectable at 1 km or beyond.

The same apparatus could be used as a close quarter illuminator and also short range optical communicator but it may be preferable to have separate covert illuminators and communicators which are optimised for the particular application.

1. A method of covert illumination comprising providing an optical source having an optical output tuned to an absorption wavelength of atmospheric oxygen, and illuminating the scene with said optical source.

2. A method according to claim 1 wherein the absorption wavelength of atmospheric oxygen corresponds to an absorption resonance of oxygen gas at wavelengths around 760 nm.

3. A method according to claim 1 wherein the atmospheric absorption wavelength is outside the visible spectrum.

4. A method as claimed in claim 1 wherein the power of the source is of the order of, or less than 1 milliwatt.

5. A method as claimed in claim 1 further comprising the step of controlling the divergence of the source so that only limited viewing directions could see the source directly.

6. A method as claimed in claim 1 wherein the optical source comprises a laser.

7. A method according to claim 1 further comprising the step of maintaining the wavelength of the source at the desired absorption wavelength.

8. A method according to claim 7 where in the step of maintaining the wavelength of the source comprising passing at least some of the output through a known sample which absorbs at the absorption wavelength of atmospheric oxygen, monitoring the level of absorption and applying feedback to the source to keep the wavelength at the peak of the absorption.

9. A method according to claim 8 wherein the known sample is provided in one or more photonic bandgap fibres capable of transmitting light at the absorption wavelength of atmospheric oxygen.

10. A method according to claim 1 wherein the absorption wavelength of atmospheric oxygen is substantially at or near the wavelength of peak response of a low light level imager.

11. A method according to claim 1 further comprising imaging the illuminated scene with a low light level imager.

12. A method according to claim 11 wherein the low light level imager is an intensified CCD imager.

13. (canceled)

14. A method as claimed in claim 1 wherein the optical output of the source is pulsed.

15. A method as claimed in claim 14 wherein the pulse timing is arranged to be synchronous with image acquisition of a gated low light level imager.

16. A method according to claim 1 further comprising the step of modulating the optical output with a data encoding.

17. (canceled)

18. A method according to claim 16 wherein the modulated output is transmitted through the atmosphere to a receiver comprising a high speed detector and a processor capable of decoding the modulation.

19. A method of covert low light level imaging comprising illuminating a scene with an optical source having an optical output tuned an absorption wavelength of atmospheric oxygen and imaging the scene with a low light level imager responsive to the wavelength of illumination.

20. (canceled)

21. An optical source tuned to an atmospheric absorption wavelength comprising a laser having a feedback control means for wavelength locking the laser output to the atmospheric absorption wavelength, wherein the feedback control means passes at least some of the laser output through a sample of the target atmospheric constituent and analyses the intensity thereof and wherein the target atmospheric constituent is held within a photonic bandgap fibre which is transmissive at the atmospheric absorption wavelength.

22. An optical source as claimed in claim 21 arranged such that all of the laser output passes through the photonic bandgap fibre and further comprising means for directing part of the radiation exiting the photonic bandgap fibre to a detector.

23. An optical source as claimed in claim 21 wherein the atmospheric absorption wavelength corresponds to an absorption of oxygen gas or water vapour.

24. (canceled)

25. (canceled)

26. (canceled)

27. (canceled)
